(19) United States
(12) Patent Application Publication
(10) Pub. No.: US 2026/0129543 A1
(43) Pub. Date: May 7, 2026

(54) METHOD FOR WIRELESS COMMUNICATION, AND TERMINAL DEVICE

(71) Applicant: GUANGDONG OPPO MOBILE TELECOMMUNICATIONS CORP., LTD., Dongguan (CN)

(72) Inventors: Xin YOU, Dongguan (CN); Xue LIN, Dongguan (CN)

(73) Assignee: GUANGDONG OPPO MOBILE TELECOMMUNICATIONS CORP., LTD., Dongguan (CN)

(21) Appl. No.: 19/369,953

(22) Filed: Oct. 27, 2025

Related U.S. Application Data
(63) Continuation of application No. PCT/CN2023/093325, filed on May 10, 2023.

(51) Int. Cl. H04W 36/36; H04W 36/00

(52) U.S. Cl. CPC H04W 36/362; H04W 36/0085

(57) ABSTRACT

Provided are a method for wireless communication, and a terminal device. The method comprises: if a condition of a first candidate cell is met and a condition of a second candidate cell is not met, a terminal device executing a first operation, wherein the first candidate cell is a conditional handover (CHO) candidate cell, the second candidate cell is a conditional primary secondary cell addition/change (CPAC) candidate cell, the first candidate cell is associated with the second candidate cell, and the first operation comprises one or more of the following: accessing the first candidate cell at a first time; accessing the first candidate cell; releasing or reserving a service secondary cell group (SCG); evaluating the second candidate cell; stopping evaluation of the second candidate cell; evaluating the first candidate cell; stopping evaluation of the first candidate cell; and residing in a source cell.

### CROSS-REFERENCE TO RELATED APPLICATIONS

This application is a continuation of International Application No. PCT/CN2023/093325, filed on May 10, 2023, the disclosure of which is hereby incorporated by reference in its entirety.

### TECHNICAL FIELD

This application relates to the field of communications technologies, and more specifically, to a method for wireless communication and a terminal device.

### BACKGROUND

In a process of a conditional handover (CHO), a terminal device may execute, based on a handover condition associated with the CHO, a handover based on a CHO candidate cell. In a process of a conditional primary secondary cell addition/change (CPAC), the terminal device may execute, based on an addition/change condition associated with the CPAC, a handover based on a CPAC candidate cell.

However, in a scenario in which the CHO and the CPAC are combined, a conditional handover event associated with the CHO and the addition/change condition associated with the CPAC are configured independently. Therefore, the following case may exist: the conditional handover event associated with the CHO and the addition/change condition associated with the CPAC are not both met. Currently, a behavior of the terminal device is not specified in a communication protocol for the foregoing case. In this case, the terminal device may have an inconsistent understanding with a network device, thereby causing a failure in communication between the terminal device and the network device.

### SUMMARY

This application provides a method for wireless communication and a terminal device. The following describes the aspects related to this application.

According to a first aspect, a method for wireless communication is provided, including: executing, by a terminal device, a first operation if a condition of a first candidate cell is met and a condition of a second candidate cell is not met, where the first candidate cell is a conditional handover CHO candidate cell, the second candidate cell is a conditional primary secondary cell addition/change CPAC candidate cell, and the first candidate cell is associated with the second candidate cell; and the first operation includes one or more of the following: accessing the first candidate cell at a first time; accessing the first candidate cell; releasing or maintaining a serving secondary cell group SCG; evaluating the second candidate cell; stopping evaluating the second candidate cell; evaluating the first candidate cell; stopping evaluating the first candidate cell; or camping on a source cell.

According to a second aspect, a method for wireless communication is provided, including: accessing, by a terminal device, a first candidate cell at a second time if a time at which a condition of a second candidate cell is met is different from a time at which a condition of the first candidate cell is met, where the first candidate cell is a conditional handover CHO candidate cell, the second candidate cell is a conditional primary secondary cell addition/change CPAC candidate cell, and the first candidate cell is associated with the second candidate cell.

According to a third aspect, a terminal device is provided, including: a processing unit, configured to execute a first operation if a condition of a first candidate cell is met and a condition of a second candidate cell is not met, where the first candidate cell is a conditional handover CHO candidate cell, the second candidate cell is a conditional primary secondary cell addition/change CPAC candidate cell, and the first candidate cell is associated with the second candidate cell; and the first operation includes one or more of the following: accessing the first candidate cell at a first time; accessing the first candidate cell; releasing or maintaining a serving secondary cell group SCG; evaluating the second candidate cell; stopping evaluating the second candidate cell; evaluating the first candidate cell; stopping evaluating the first candidate cell; or camping on a source cell.

According to a fourth aspect, a terminal device is provided, including: a processing unit, configured to access a first candidate cell at a second time if a time at which a condition of a second candidate cell is met is different from a time at which a condition of the first candidate cell is met, where the first candidate cell is a conditional handover CHO candidate cell, the second candidate cell is a conditional primary secondary cell addition/change CPAC candidate cell, and the first candidate cell is associated with the second candidate cell.

According to a fifth aspect, a terminal device is provided, including a processor, a memory, and a communications interface, where the memory is configured to store one or more computer programs, and the processor is configured to invoke the computer program in the memory, to cause the terminal device to execute some or all of the steps in a method according to the foregoing aspects.

According to a sixth aspect, an embodiment of this application provides a communications system, where the system includes the foregoing terminal device and/or the foregoing network device. In another possible design, the system may further include another device that interacts with the terminal device or the network device in the solutions provided in embodiments of this application.

According to a seventh aspect, an embodiment of this application provides a computer-readable storage medium, where the computer-readable storage medium stores a computer program, and the computer program causes a communications device (for example, a terminal device or a network device) to execute some or all of steps in a method according to each of the foregoing aspects.

According to an eighth aspect, an embodiment of this application provides a computer program product, where the computer program product includes a non-transitory computer-readable storage medium that stores a computer program, and the computer program is operable to cause a communications device (for example, a terminal device or a network device) to execute some or all of steps in a method according to each of the foregoing aspects. In some implementations, the computer program product may be a software installation package.

According to a ninth aspect, an embodiment of this application provides a chip, where the chip includes a memory and a processor, and the processor may invoke a computer program from the memory and run the computer program, to implement some or all of steps described in a method according to each of the foregoing aspects.

### BRIEF DESCRIPTION OF DRAWINGS

FIG. 1 shows a wireless communications system 100 to which embodiments of this application are applied.

FIG. 2 is a schematic diagram of a conventional handover procedure to which embodiments of this application are applicable.

FIG. 3 is a schematic flowchart of a wireless communication method according to an embodiment of this application.

FIG. 4 is a schematic diagram of accessing a CPAC candidate cell based on a relaxed condition according to an embodiment of this application.

FIG. 5 is a schematic diagram of a terminal device according to an embodiment of this application.

FIG. 6 is a schematic diagram of a terminal device according to another embodiment of this application.

FIG. 7 is a schematic structural diagram of a communications apparatus according to an embodiment of this application.

### DESCRIPTION OF EMBODIMENTS

The following describes technical solutions of this application with reference to the accompanying drawings.

A method provided in embodiments of this application may be applied to various multiple RAT dual connectivity (MR-DC) architectures, for example, dual connectivity of a fourth-generation (4G) communications system and a fifth-generation (5G) communications system, dual connectivity of a 5G communications system and a 4G communications system, or dual connectivity of a 5G communications system and a 5G communications system.

The dual connectivity of a 4G communications system and a 5G communications system may include: dual connectivity of an evolved universal terrestrial radio access (E-UTRA) system and a new radio (NR) system (E-UTRA-NR dual connectivity, EN-DC), dual connectivity of an E-UTRA system under a 5G core network and an NR system (NG-RAN E-UTRA-NR dual connectivity, NGEN-DC), and the like. The EN-DC may also be referred to as an option 3 series. The EN-DC uses a long-term evolution (LTE) base station, for example, an eNB, as a master node (MN) or a primary base station, and uses an NR base station, for example, a gNB, as a secondary node (SN) or a DC of a secondary base station. The MN and the SN may separately have a data plane connection to an evolved packet core (EPC) network, that is, a 4G core network, to provide an air interface transmission resource for data between a terminal and the EPC. The NGEN-DC may also be referred to as an option 7 series. The NG EN-DC uses an LTE base station, for example, an ng-eNB, as an MN, and uses an NR base station, for example, a gNB, as a DC of an SN. Different from the EN-DC, in the NG EN-DC, both the MN and the SN are connected to a 5G core network (5GC), to provide an air interface transmission resource for data between a terminal and the 5GC.

The dual connectivity of a 5G communications system and a 4G communications system may include dual connectivity of an NR system and an E-UTRA system (NRE-UTRA dual connectivity, NE-DC) and the like. The NE-DC may also be referred to as an option 4 series. The NE-DC uses an NR base station, for example, a gNB, as an MN, and uses an LTE base station, for example, an ng-eNB, as an SN. The MN and the SN may separately have a data plane connection to a 5GC, to provide an air interface transmission resource for data between a terminal and the 5GC.

The dual connectivity of a 5G communications system and a 5G communications system may include an NR system and a DC of an NR system. In the NR system and the DC of the NR system, an MN and an SN are both NR base stations.

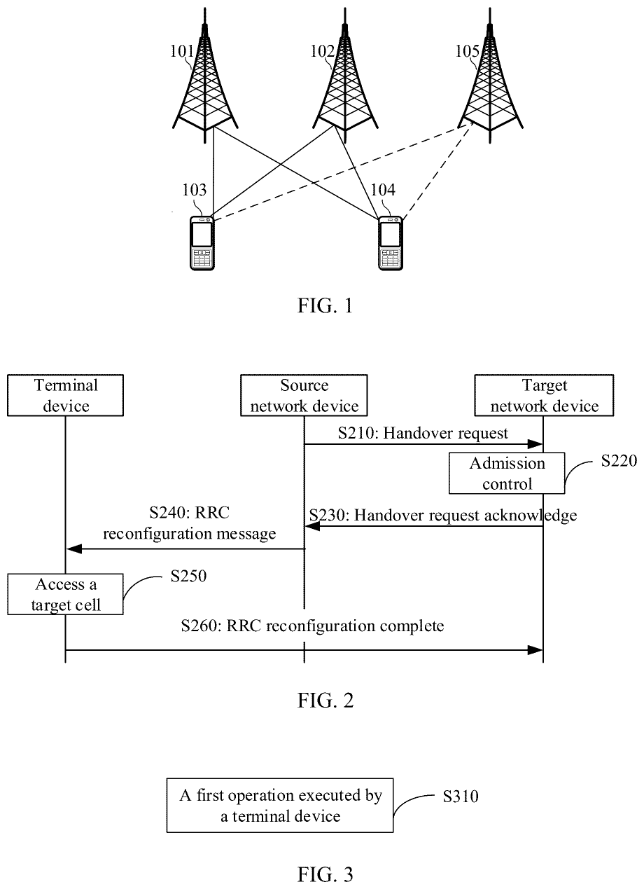

The following describes the methods provided in embodiments of this application by using only a communications system 10 shown in FIG. 1 as an example.

FIG. 1 is a schematic architecture diagram of the communications system 10 according to an embodiment of this application. In FIG. 1, the communications system 10 may include a network device 101, a network device 102, a network device 105, a terminal device 103, and a terminal device 104. FIG. 1 is only a schematic diagram, and does not constitute a limitation on an applicable scenario of the technical solutions provided in this application.

A network device in FIG. 1, that is, the network device 101, the network device 102, or the network device 105, may be any device that has a wireless receiving and transmitting process. The network devices include but are not limited to an evolved Node B (eNB, or e-NodeB) in LTE, a base station (gNodeB or gNB) or a transmission reception point (TRP) in NR, a subsequently evolved base station in 3GPP, and the like. The base station may be a macro base station, a micro base station, a picocell base station, a small cell, a relay station, a balloon station, or the like. A plurality of base stations may support a network of a same technology mentioned above, or may support networks of different technologies mentioned above. The base station may include one or more TRPs located at a same site or one or more TRPs not located at a same site. The network device may alternatively be a radio controller, a centralized unit (CU), and/or a distributed unit (DU) in a cloud radio access network (CRAN) scenario.

A terminal in FIG. 1, that is, the terminal device 103 or the terminal device 104, is a device that has a wireless receiving and transmitting process, and may be deployed on land, including indoor or outdoor, handheld, wearable, or vehicle-mounted, may be deployed on water (for example, on a ship), or may be deployed in air (for example, on an airplane, a balloon, or a satellite). The terminal may be a mobile phone, a tablet computer (Pad), a computer with a wireless receiving and transmitting process, a virtual reality (VR) terminal device, an augmented reality (AR) terminal device, a terminal in industrial control, a vehicle-mounted terminal device, a terminal in self-driving, a terminal in assisted driving, a terminal in remote medical, a terminal in a smart grid, a terminal in transportation safety, a terminal in a smart city, a terminal in a smart home, or the like. An application scenario is not limited in embodiments of this application. The terminal sometimes may be referred to as a terminal device, a user equipment (UE), an access terminal, a vehicle-mounted terminal, an industrial control terminal, a UE unit, a UE station, a mobile site, a mobile station, a remote station, a remote terminal, a mobile device, a UE terminal device, a wireless communications device, a machine terminal, a UE agent, a UE apparatus, or the like. The terminal may be fixed or mobile.

As an example instead of a limitation, in embodiments of this application, the terminal may be a wearable device. The wearable device may also be referred to as a wearable intelligent device, and is a general term for wearable devices such as glasses, gloves, watches, clothes, and shoes that are intelligently designed and developed by applying wearable technologies to daily wearing. The wearable device is a portable device that can be directly worn or integrated into clothes or accessories of a user. In addition to being a hardware device, the wearable device also implements a powerful process through software support, data interaction, and cloud interaction. In a broad sense, the wearable smart device includes a full-process and large-sized device that may implement all or some processes without relying on a smartphone, for example, a smart watch or smart glasses, and a device that only focus on a specific type of application process and needs to be used in cooperation with another device such as a smartphone, for example, various smart bracelets and smart jewelries for physical sign monitoring.

For ease of understanding, the following describes communication processes involved in embodiments of this application.

### Conventional Handover Process

Similar to an LTE system, an NR system supports a handover process performed by a terminal device in a connected state. When a terminal device that is using a network service moves from one cell to another cell, or due to reasons such as adjustment of a load of a wireless transmission service, activation operation and maintenance, and a device fault, to ensure continuity and quality of service of communication, a network device needs to hand over a communications link between the terminal device and an original cell (also referred to as a “source base station”) to the new cell (also referred to as “a target cell or a target base station”), that is, execute a handover process.

For ease of understanding, the following describes a conventional handover process with reference to FIG. 2. Referring to FIG. 2, a method shown in FIG. 2 includes step S210 to step S260.

In step S210, a source network device triggers a handover based on an L3 measurement result reported by a terminal device, and transmits, through an Xn interface, a handover request (HANDOVER REQUEST) to a target network device on which a target cell is located.

In step S220, the target network device executes admission control in response to the handover request.

In step S230, the target network device transmits a handover request acknowledge (HANDOVER REQUEST ACKNOWLEDGE) message to the source network device.

In some implementations, the handover request acknowledge may include an RRC configuration of the target cell.

In step S240, the source network device transmits an RRC reconfiguration message to the terminal device, to instruct the terminal device to initiate a handover process.

In some implementations, the RRC reconfiguration message includes RRC configuration information used to access the target cell.

In step S250, the terminal device accesses the target cell.

In step S260, the terminal device transmits an RRC reconfiguration complete message to the target network device.

### CPAC Process

For ease of understanding, the following describes a CPAC process with reference to FIG. 1. In FIG. 1, the terminal device 103 or the terminal device 104 may implement dual connectivity to the network device 101 and the network device 102. Herein, one network device is an MN, and the other network device is an SN. One or more serving cells of the MN belong to a master cell group (MCG). Generally, the MCG may include a primary cell (PCell). In some implementations, in addition to the PCell, the MCG may further include one or more secondary cells (SCell). One or more serving cells of the SN belong to a secondary cell group (SCG). Generally, the SCG may include a primary secondary cell (PSCell). In some implementations, in addition to the PSCell, the SCG may further include one or more SCells.

In the communications system 10 shown in FIG. 1, the terminal device 103 or the terminal device 104 may perform a CPAC. For example, the terminal device 103 may perform a conditional primary secondary cell addition (conditional PSCell addition, CPA) by the following example 1 and perform a conditional primary secondary cell change (conditional PSCell change, CPC) by the following example 2.

In the example 1, the terminal device 103 has established an RRC connection to the network device 101, and the terminal device 103 needs to perform a CPA to establish a connection to the network device 102. After the network device 101 establishes the RRC connection to the terminal device 103, one or more candidate PSCells may be configured for the terminal device 103. The one or more candidate PSCells include a PSCell configured by the network device 102 for the terminal device 103 and a PSCell configured by another network device for the terminal device 103. The network device 101 transmits configuration information 1 of the one or more candidate PSCells to the terminal device 103, where the configuration information 1 of a candidate PSCell includes a configuration 1 and an addition condition of the candidate PSCell. The terminal device 103 receives the configuration information 1 of the one or more candidate PSCells from the network device 101, and may detect the addition condition of the one or more candidate PSCells. When detecting at least one candidate PSCell that meets the addition condition, the terminal device 103 selects one candidate PSCell (for example, the candidate PSCell configured by the network device 102 for the terminal), and applies a configuration of the candidate PSCell. Subsequently, the terminal device 103 initiates random access to the candidate PSCell, and establishes dual connectivity to the network device 101 and the network device 102 after the random access to the candidate PSCell succeeds. The configuration information 1 of the candidate PSCells may also be referred to as CPA configuration information 1 of the candidate PSCells. A name of the configuration information is not limited in embodiments of this application.

It may be understood that when detecting a plurality of candidate PSCells that meet respective addition conditions, the terminal device 103 may select one candidate PSCell according to a preset policy and apply a configuration of the candidate PSCell. For example, when detecting the plurality of candidate PSCells that meet the respective addition conditions, the terminal device 103 may randomly select one candidate PSCell and apply a configuration of the candidate PSCell. Alternatively, the terminal device 103 may select a candidate PSCell with the best signal quality from the plurality of candidate PSCells that meet the respective addition conditions, and apply a configuration of the candidate PSCell. Alternatively, the terminal device 103 may select a candidate PSCell with the largest quantity of beams from the plurality of candidate PSCells that meet the respective addition conditions and whose quantities of beams are greater than or equal to a threshold value, and apply a configuration of the candidate PSCell. The foregoing is merely an example in which the terminal device 103 selects a candidate PSCell. The terminal device 103 may alternatively select a candidate PSCell in another manner, which is not limited.

In the example 2, the terminal device 103 has established dual connectivity to the network device 101 and the network device 102, the network device 101 is an MN, the network device 102 is an SN, and the terminal device 103 needs to perform a CPC. The network device 101 may configure one or more candidate PSCells for the terminal device 103. The network device 101 transmits configuration information 2 of the one or more candidate PSCells to the terminal device 103, where the configuration information 2 of a candidate PSCell includes a configuration 2 and a change condition of the candidate PSCell. The terminal device 103 receives the configuration information 2 of the one or more candidate PSCells from the network device 101, and may detect the change conditions of the one or more candidate PSCells. When detecting at least one candidate PSCell that meets the respective change condition, the terminal device 103 selects one candidate PSCell and applies a configuration of the candidate PSCell. Subsequently, the terminal device 103 initiates random access to the candidate PSCell, and establishes dual connectivity to the network device 101 and a secondary base station to which the candidate PSCell belongs after the random access to the candidate PSCell succeeds. The configuration information 2 of the candidate PSCell may also be referred to as CPC configuration information 2 of the candidate PSCell, which is not limited.

It may be understood that when detecting a plurality of candidate PSCells that meet the respective change conditions, the terminal device 103 may select one candidate PSCell according to a preset policy and apply a configuration of the candidate PSCell. For example, when detecting the plurality of candidate PSCells that meet the respective change conditions, the terminal device 103 may randomly select one candidate PSCell, and apply a configuration of the candidate PSCell. Alternatively, the terminal device 103 may select a candidate PSCell with the best signal quality from the plurality of candidate PSCells that meet the respective change conditions, and apply a configuration of the candidate PSCell. Alternatively, the terminal device 103 may select a candidate PSCell with the largest quantity of beams from the plurality of candidate PSCells that meet the respective change conditions and whose quantities of beams are greater than or equal to a threshold value, and apply a configuration of the candidate PSCell. The foregoing is merely an example in which the terminal device 103 selects a candidate PSCell. The terminal device 103 may alternatively select a candidate PSCell in another manner, which is not limited.

It should be noted that, in embodiments of this application, for any candidate PSCell in one or more candidate PSCells configured by any network device for the terminal, the configuration information 1 of the candidate PSCell used when the terminal performs a CPA and the configuration information 2 of the candidate PSCell used when the terminal performs a CPC may be collectively referred to as configuration information of the candidate PSCell. The configuration 1 of the candidate PSCell used when the terminal performs a CPA and the configuration 2 of the candidate PSCell used when the terminal performs a CPC may be collectively referred to as a configuration of the candidate PSCell. The configuration information of a candidate PSCell includes a configuration and an addition/change condition of the candidate PSCell. When the terminal performs a CPA, the configuration of the candidate PSCell is used by the terminal to communicate with the candidate PSCell after the terminal adds the candidate PSCell. The addition/change condition of the candidate PSCell includes an addition condition of the candidate PSCell, and the candidate PSCell addition condition is used by the terminal to determine whether to add the candidate PSCell. When the terminal performs a CPC, the configuration of the candidate PSCell is used by the terminal to communicate with the candidate PSCell after the terminal changes from a source PSCell to the candidate PSCell, the addition/change condition of the candidate PSCell includes a change condition of the candidate PSCell, and the change condition of the candidate PSCell is used by the terminal to determine whether to change the source PSCell to the candidate PSCell.

When the terminal device 103 receives configurations and addition/change conditions of one or more candidate PSCells but does not detect a PSCell that meets the respective addition/change condition, the terminal device 103 may be further handed over from a current MN to a target MN with better signal quality. For example, the terminal device 103 may be handed over from the network device 101 to the network device 105. Generally, after the terminal device 103 executes the MN handover, the current MN releases the one or more candidate PSCells configured for the terminal device 103. After establishing an RRC connection to the terminal device 103, the target MN may newly configure one or more candidate PSCells for the terminal device 103, and transmit, to the terminal device 103, configuration information of the one or more candidate PSCells configured by the target MN for the terminal, so that the terminal performs a CPAC. The configuration information of the one or more candidate PSCells configured by the target MN for the terminal includes configurations and an addition/change conditions of the candidate PSCells.

Generally, the configuration and the addition/change condition of a candidate PSCell include much information. For example, the configuration of the candidate PSCell includes an identity configured for the candidate PSCell, and/or a random access resource allocated by the candidate PSCell to the terminal, and/or a cell radio network temporary identifier (CRNIT), and/or a cell global identification (CGI) of the candidate PSCell, and/or a physical cell identity (PCI) of the candidate PSCell, and/or frequency information corresponding to the candidate PSCell. The frequency information corresponding to the candidate PSCell may include one or more of the following: an absolute frequency (for example, absoluteFrequency SSB) of a synchronization signal block, an absolute frequency position (for example, absoluteFrequencyPointA) of a reference resource module (a common RB 0), a frequency bandwidth list (for example, frequencyBandList), a subcarrier spacing (SCS)-specific carrier list (for example, scs-SpecificCarrierList), or the like. The configuration of the candidate PSCell further includes resource information corresponding to the candidate PSCell, where the resource information corresponding to the candidate PSCell includes one or more of the following: a bearer configuration parameter (radioBearerConfig), a cell group configuration (cellGroupConfig) parameter, a physical layer (PHY layer) configuration parameter, a medium access control (MAC) layer configuration parameter, a radio link control (RLC) layer configuration parameter, a packet data convergence protocol (PDCP) layer configuration parameter, a service data adaptation protocol (SDAP) layer configuration parameter, or an RRC layer configuration parameter. The configuration of the candidate PSCell may also be referred to as a CPAC configuration of the candidate PSCell, CPAC configuration information of the candidate PSCell, or the like. A name of the foregoing configuration is not specifically limited in embodiments of this application.

The addition/change condition of the candidate PSCell is used by the terminal to determine whether to add the candidate PSCell, or is used by the terminal to determine whether to change the source PSCell to the candidate PSCell. For example, if the terminal detects that the candidate PSCell meets the addition/change condition of the candidate PSCell, the terminal determines to add the candidate PSCell or change the source PSCell to the candidate PSCell. If the terminal detects that the candidate PSCell does not meet the addition/change condition of the candidate PSCell, the terminal determines not to add the candidate PSCell or not to change the source PSCell to the candidate PSCell.

Optionally, the addition/change condition of the candidate PSCell includes an execution event type of the addition/change condition of the candidate PSCell, where the execution event type may also be referred to as a measurement event or a reporting event. The terminal may measure signal quality of the candidate PSCell, or measure signal quality of the candidate PSCell and signal quality of a neighboring cell of the candidate PSCell, and determine, based on a measurement result and the execution event type, whether to add the candidate PSCell, or determine whether to change the source PSCell to the candidate PSCell.

Generally, before the terminal device executes the CPAC process described above, a network device provides a CPAC configuration for the terminal device. Correspondingly, the terminal device changes the PSCell based on the CPAC configuration provided by the network device. In some implementations, the network device may determine, based on a service condition (for example, a transmission delay, a data amount of to-be-transmitted data, and the like) and a channel measurement condition (for example, a channel state), whether the terminal device requires a CPAC.

In addition, in some implementations, the foregoing CPAC configuration may include a candidate cell configuration list, an execution condition, and a cell configuration.

The foregoing candidate cell list may be understood as a candidate cell configuration list used for a CPA or a CPC. The candidate cell list may include cell information of one or more candidate cells, where cell information of each candidate cell may include an identifier of configuration information. It should be noted that the ID of the configuration information may be determined based on a quantity of candidate cells configured by the network device for the terminal device. For example, the network device provides configurations of five candidate cells for the terminal device. In this case, the foregoing ID of the configuration information of the cell may be used to identify the configurations of the five candidate cells.

The foregoing execution condition may be an execution condition used to indicate, to the terminal device, executing a CPA or a CPC. The execution condition is also referred to as a “CPAC condition”, or a condition used for a CPAC, or a condition of a CPAC candidate cell.

An implementation of the CPAC condition is not limited in embodiments of this application. For example, the CPAC condition may include an event A3 (CondEvent A3). Correspondingly, if quality of service (for example, RSRP) of a neighboring cell is higher than that of a serving cell (PCell/PSCell) by an absolute threshold, an A3 event handover is triggered.

For another example, the CPAC condition may include an event A4 (CondEvent A4). Correspondingly, if an RSRP value of a neighboring cell is greater than a threshold, an A4 event handover is triggered.

For another example, the CPAC condition may include an event A5 (CondEvent A5). Correspondingly, quality of service of a serving cell is lower than an absolute threshold 1, and quality of service of a neighboring cell is higher than an absolute threshold 2. In this case, an A5 event handover is triggered.

The foregoing cell configuration may be an SCG configuration provided by a candidate SN for an MN. In some implementations, the foregoing SCG configuration may be transmitted by the SN to the MN through an Xn interface, and is correspondingly transparently transmitted by the MN to the terminal device. In an implementation, the foregoing SCG configuration may include a configuration of a candidate SCG, where the configuration of the candidate SCG may include a cell ID, a radio bearer configuration, a logical channel configuration, an RLC configuration, a MAC configuration, a physical layer configuration, and an SCell configuration.

It should be noted that as described above, one SCG may include one or more SCells. Correspondingly, the foregoing SCG configuration may include configurations of one or more Scells. This is not limited in embodiments of this application.

In addition, in embodiments of this application, a CPC and a CPA in a CPAC may be in an OR relationship. That is, a CPAC in embodiments of this application may be replaced with “a CPA or a CPC” or may be represented as a “CPA/CPC”.

### CHO

For a CHO mechanism, a network device may configure, for a terminal device, configurations of one or more CHO candidate cells and conditional handover events associated with the one or more CHO candidate cells. Correspondingly, the terminal device may execute a handover condition evaluation task, to evaluate whether the conditional handover events associated with the one or more CHO candidate cells are met. When the conditional handover events associated with the one or more CHO candidate cells are met, the terminal device may be handed over from a source cell (or referred to as a “current serving cell”) to a corresponding CHO candidate cell that meets the conditional handover event. In this case, the CHO candidate cell accessed by the terminal device may be referred to as “a target cell or a target CHO cell”.

### Process of Combining a CHO With a CPAC

Currently, some communication protocols (for example, R17) support carrying configuration information of an SCG in a configuration of a CHO candidate cell, so that a terminal device can quickly establish dual connectivity. Because the CHO candidate cell is preconfigured, an SCG addition failure may be triggered due to an improper configuration of an SCG cell. Therefore, in some other communication protocols (for example, R10), a mechanism for combining a CHO with a CPAC is introduced. This mechanism is also referred to as a “CHO+CPAC process”, that is, a CHO candidate cell may be associated with at least one CPAC candidate cell. In this way, a terminal device may select a corresponding SCG based on a condition and execute an addition, which may improve the situation of an improper configuration of an SCG cell.

In some implementations, a CHO executed by the terminal device may be triggered by a serving MN (or a source MN). In addition, a CHO candidate cell of the terminal device may be determined by the serving MN (or the source MN).

In some other implementations, a CPAC executed by the terminal device may be triggered by one or more nodes in the serving MN (or the source MN), a serving SN, or a candidate SN. Correspondingly, a CPAC candidate cell may be determined by the triggering node.

In some other implementations, a configuration of the CHO candidate cell and/or a configuration of a CPA or CPC candidate cell may be provided by a candidate MN and/or the candidate SN. Executing evaluation on a condition of a candidate cell includes evaluating a measurement event associated with the condition of the candidate cell.

As described above, in a process of a CHO, a terminal device may execute, based on a handover condition associated with the CHO, a handover based on a CHO candidate cell. In a process of a CPAC, a terminal device may execute, based on an addition/change condition associated with the CPAC, a handover based on a CPAC candidate cell. However, in a scenario in which the CHO and the CPAC are combined, a conditional handover event associated with the CHO and the addition/change condition associated with the CPAC are configured independently. Therefore, the following case may exist: the conditional handover event associated with the CHO and the addition/change condition associated with the CPAC are not both met. Currently, a behavior of the terminal device is not specified in a communication protocol for the foregoing case. In this case, the terminal device may have an inconsistent understanding with a network device, thereby causing a failure in communication between the terminal device and the network device.

Therefore, for the foregoing problem, an embodiment of this application provides a method for wireless communication, to specify a behavior of a terminal device in the foregoing case. The following describes the method according to this embodiment of this application based on a scenario 1 and a scenario 2.

Scenario 1: A condition of a first candidate cell is met and a condition of a second candidate cell is not met.

The first candidate cell may be a CHO candidate cell, or in other words, a candidate cell associated with a CHO. In some implementations, the CHO candidate cell may be used to select an MN, or in other words, the CHO candidate cell may be used to select a PCell, or in other words, the CHO candidate cell may be used to select an MCG. Correspondingly, the condition of the first candidate cell may be understood as a CHO handover condition associated with the first candidate cell, or in other words, a handover condition used when the CHO for the first candidate cell is executed. For example, the condition of the first candidate cell may include a conditional handover event used for executing the CHO for the first candidate cell. Generally, when the condition of the first candidate cell is met, a terminal device may access the first candidate cell.

In addition, a quantity of first candidate cells is not limited in embodiments of this application. For example, the first candidate cell may include one or more CHO candidate cells. For ease of description, the following uses an example in which the first candidate cell includes one CHO candidate cell for description. The solution according to this embodiment of this application is also applicable to a case in which the first candidate cell includes a plurality of CHO candidate cells.

The second candidate cell may be a CPAC candidate cell, or in other words, a candidate cell associated with a CPAC. In some implementations, the CPAC candidate cell may be used to select an SN, or in other words, the CPAC candidate cell may be used to select a PSCell, or in other words, the CPAC candidate cell may be used to select an SCG. Correspondingly, the condition of the second candidate cell may be understood as an addition/change condition associated with the second candidate cell, or in other words, an addition/change condition used when the CPAC for the second candidate cell is executed. Generally, when the condition of the second candidate cell is met, the terminal device may access the second candidate cell. In this embodiment of this application, accessing the second candidate cell may also be referred to as adding or changing the second candidate cell.

In addition, a quantity of second candidate cells is not limited in embodiments of this application. For example, there may be one or more second candidate cells.

The second candidate cell is associated with the first candidate cell. For example, a configuration of the first candidate cell carries configuration information of the second candidate cell.

The foregoing describes the scenario 1 of this embodiment of this application. With reference to FIG. 3, the following describes a behavior of a terminal device in Embodiment 1 to Embodiment 6, that is, a first operation (referring to step S310) executed by the terminal device.

Embodiment 1: The first operation includes accessing, by a terminal device, a first candidate cell at a first time.

In some implementations, the first time is determined based on a time at which a condition of a second candidate cell is met. For example, the first time may be the time at which the condition of the second candidate cell is met. Certainly, in this embodiment of this application, the first time may alternatively be any time later than the time at which the condition of the second candidate cell is met.

If the first time is the time at which the condition of the second candidate cell is met, executing, by the terminal device, the first operation may be understood as: the terminal device accesses the first candidate cell in a case in which the condition of the second candidate cell is met, or in other words, the terminal device accesses the first candidate cell when the condition of the second candidate cell is met.

It should be noted that if the terminal device accesses the first candidate cell, the terminal device may access the second candidate cell. That is, when the condition of the second candidate cell is met, the terminal device may access both the first candidate cell and the second candidate cell. Certainly, in this embodiment of this application, the terminal device may alternatively not access the second candidate cell.

Meeting the condition of the second candidate cell is not limited in embodiments of this application. In some implementations, meeting the condition of the second candidate cell may be understood as: the condition of the second candidate cell is met after being relaxed, or in other words, the relaxed condition of the second candidate cell is met, or in other words, the condition of the second candidate cell is met after measurement for the second candidate cell is relaxed. Correspondingly, the time at which the condition of the second candidate cell is met may be determined based on a time corresponding to that the relaxed condition of the second candidate cell is met.

In other words, the time at which the condition of the second candidate cell is met is determined based on a time at which a target condition of the second candidate cell is met. The target condition is obtained by relaxing the condition of the second candidate cell. In other words, the time at which the condition of the second candidate cell is met is based on a time at which the condition of the second candidate cell is met after the measurement for the second candidate cell is relaxed.

In this embodiment of this application, that the time at which the condition of the second candidate cell is met is determined based on the time at which the target condition of the second candidate cell is met may be understood as: the time at which the condition of the second candidate cell is met is equal to the time at which the target condition of the second candidate cell is met. Certainly, the time at which the condition of the second candidate cell is met may be later than the time at which the target condition of the second candidate cell is met.

In some implementations, the terminal device generally monitors a channel condition of the second candidate cell, to determine whether the condition of the second candidate cell is met, and the terminal device can access the second candidate cell only when the condition of the second candidate cell is always met within a predefined time period (for example, a time-to-trigger TTT). Correspondingly, in this embodiment of this application, relaxing the measurement for the second candidate cell may include skipping measuring channel conditions of one or more neighboring cells (including the second candidate cell) within the predefined time period, or in other words, may include not needing to measure the channel conditions of the one or more neighboring cells (including the second candidate cell) within the predefined time period, or in other words, may include adjusting duration of the predefined time period to 0.

Certainly, in this embodiment of this application, relaxing the measurement for the second candidate cell may further include shortening the duration of the predefined time period. For example, after the measurement for the second candidate cell is relaxed, duration of a TTT associated with the second candidate cell is less than an original TTT associated with the second candidate cell, where the original TTT is a TTT used before the measurement for the second candidate cell is relaxed.

In addition, the condition of the second candidate cell may include, for example, one or more of an event A3, an event A4, or an event A5. Certainly, the condition of the second candidate cell may alternatively include another condition, which is not limited in embodiments of this application.

For example, a CHO candidate cell 1 is associated with a CPAC candidate cell 1. If the CHO candidate cell 1 meets an entering condition, the CHO candidate cell 1 needs to be continuously measured during a TTT 1 corresponding to the CHO candidate cell 1, to determine that the CHO candidate cell 1 meets the condition during the TTT 1. Only when the CHO candidate cell 1 meets the condition during the TTT 1, it can be considered that the CHO candidate cell 1 meets the condition. Similarly, if the CPAC candidate cell 1 meets the entering condition, the CPAC candidate cell 1 needs to be continuously measured during a TTT 2 corresponding to the CPAC candidate cell 1, to determine that the CPAC candidate cell 1 meets the condition during the TTT 2. Only when the CPAC candidate cell 1 meets the condition during the TTT 2, it can be considered that the CPAC candidate cell 1 meets the condition.

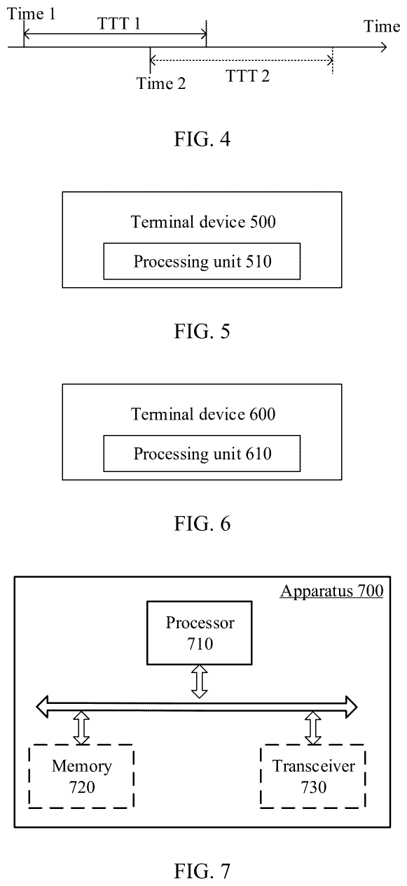

Referring to FIG. 4, it is assumed that the CHO candidate cell 1 meets the entering condition at a time 1, and also meets the condition during the TTT 1 corresponding to the CHO candidate cell 1. The CPAC candidate cell 1 meets the entering condition at a time 2, but does not meet the condition within the TTT 2 corresponding to the CPAC candidate cell 1. In this case, by using the solution according to this embodiment of this application, the condition of the CPAC candidate cell 1 may be relaxed, so as to consider that the condition of the CHO candidate cell 1 and the condition of the CPAC candidate cell 1 are both met. Correspondingly, the terminal device may access the CHO candidate cell 1 and the CPAC candidate cell 1.

For another example, after the first candidate cell meets the condition, the terminal device may evaluate the second candidate cell. If the second candidate cell meets the entering condition, it is considered that the condition of the second candidate cell is met.

In some other implementations, the condition of the second candidate cell may be associated with a threshold. Correspondingly, the target condition (or the relaxed condition of the second candidate cell) may include a reduced threshold.

For example, the condition of the second candidate cell includes that if a measurement result of the second candidate cell is greater than a threshold value 1, the condition of the second candidate cell is met. Correspondingly, in this embodiment of this application, the target condition is used to indicate that if the measurement result of the second candidate cell is greater than a threshold value 2, the condition of the second candidate cell is met, where the threshold value 1 is greater than the threshold value 2.

Certainly, in this embodiment of this application, the condition of the second candidate cell may alternatively be relaxed in another manner. In some implementations, the condition of the second candidate cell may be relaxed by adjusting the measurement result of the second candidate cell. For example, the condition of the second candidate cell includes that if a difference between the measurement result of the second candidate cell and a preset parameter 1 is greater than a threshold value, the condition of the second candidate cell is met. Correspondingly, in this embodiment of this application, the target condition is used to indicate that if a difference between the measurement result of the second candidate cell and a preset parameter 2 are greater than a threshold value, the condition of the second candidate cell is met, where the preset parameter 1 is greater than the preset parameter 2.

A manner of adjusting a preset parameter is not limited in embodiments of this application. In addition to relaxing the condition of the second candidate cell by reducing a preset parameter as described above, in some implementations, the condition of the second candidate cell may alternatively be relaxed by increasing a preset parameter. For example, if the condition of the second candidate cell includes an event A3 (CondEvent A3), the condition of the second candidate cell may be relaxed by increasing a preset parameter.

The foregoing describes the first time in this embodiment of this application by using an example in which the first time is determined based on the time at which the condition of the second candidate cell is met. Certainly, in this embodiment of this application, the first time may be independent of the time at which the condition of the second candidate cell is met.

In some implementations, the first time may be associated with a first timer. In some implementations, a stopping time of the first timer may be the first time, or the first time may be a time after the first timer stops.

In some implementations, the first timer is used to indicate duration of evaluating a candidate cell, that is, the terminal device may evaluate the candidate cell during running of the first timer.

The candidate cell is not limited in embodiments of this application. For example, the candidate cell may include one or more of the following: the first candidate cell, the second candidate cell, or another candidate cell. The another candidate cell may be understood as a candidate cell in a plurality of CHO candidate cells of the terminal device other than the first candidate cell. Certainly, in this embodiment of this application, the another candidate cell may further include one or more CPAC candidate cells associated with the another candidate cell.

A starting condition or a restarting condition of the first timer is not limited in embodiments of this application. In some implementations, the starting condition or the restarting condition of the first timer includes that the condition of the first candidate cell is met, that is, the terminal device starts or restarts the first timer in response to that the condition of the first candidate cell is met.

In some other implementations, the restarting condition of the first timer includes that a condition of a third candidate cell is met during running of the first timer, where the third candidate cell is a CHO-based candidate cell (also referred to as a “CHO candidate cell”) other than the first candidate cell.

For example, in response to that the condition of the CHO candidate cell 1 is met, the terminal device starts the first timer, and evaluates another candidate cell during running of the first timer. In this case, if a condition of a CHO candidate cell 2 is met, the terminal device may restart the first timer.

A stopping condition of the first timer is not limited in embodiments of this application. In some implementations, the stopping condition of the first timer includes one or more of the following: the condition of the second candidate cell is met; a measurement result of a source cell of the terminal device is lower than a threshold; a radio link failure (RLF) occurs in the source cell of the terminal device; or an RLF-related timer is started.

For example, the stopping condition of the first timer includes that the condition of the second candidate cell is met. If the condition of the second candidate cell is met, the terminal device no longer needs to evaluate a CHO candidate cell (for example, including the first candidate cell) and/or a CPAC candidate cell (for example, including the second candidate cell). In this case, the first timer may be stopped. That the condition of the second candidate cell is met may include: the relaxed condition of the second candidate cell is met, or the non-relaxed condition of the second candidate cell is met.

For example, the stopping condition of the first timer includes that the measurement result of the source cell of the terminal device is lower than the threshold. If signal quality of the source cell is lower than a signal quality threshold, it indicates that the terminal device cannot communicate with a network device by using the source cell. In this case, the terminal device may stop the first timer and access the first candidate cell at the first time, so that the terminal device may maintain communication with the network device.

In some scenarios, for some reasons, the measurement result of the source cell may be lower than the threshold only temporarily. If the terminal device immediately stops the first timer and is handed over to the first candidate cell once the terminal device detects that the measurement result of the source cell is lower than the threshold, resources may be wasted due to frequent handovers of the terminal device. Therefore, in some implementations, the stopping condition of the first timer may include that the measurement result of the source cell is lower than the threshold within a first time period, or in other words, the measurement result of the source cell is continuously lower than the threshold within the first time period. The first time period may be predefined duration. For example, the first time period may be controlled based on a timer.

The measurement result is not limited in embodiments of this application. In some implementations, the measurement result may include the signal quality of the source cell, and correspondingly, the threshold may be a signal quality threshold. The signal quality may be, for example, reference signal received quality (RSRQ). In some other implementations, the measurement result may include signal received power of the source cell, and correspondingly, the threshold may be a signal received power threshold, where the signal received power may be, for example, reference signal received power (RSRP).

For example, the stopping condition of the first timer includes that an RLF occurs in the source cell of the terminal device. If an RLF occurs in the source cell, it indicates that the terminal device cannot communicate with the network device by using the source cell. In this case, the terminal device may stop the first timer and access the first candidate cell at the first time, so that the terminal device may maintain communication with the network device.

For example, the stopping condition of the first timer includes that an RLF-related timer is started. If the terminal device starts the RLF-related timer, it indicates that the terminal device may not be able to communicate with the network device by using the source cell. In this case, the terminal device may stop the first timer and access the first candidate cell at the first time, so that the terminal device may maintain communication with the network device.

In some implementations, the RLF-related timer may include a timer used to instruct the terminal device to monitor a radio link failure, for example, a timer 310(T310). Generally, the terminal device starts the timer when monitoring that a problem occurs at a physical layer of a primary serving cell (for example, when receiving N310 consecutive out-of-sync (out-of-sync) indications).

Certainly, in this embodiment of this application, the stopping condition of the first timer may alternatively include another condition. In some implementations, the first candidate cell may be associated with one or more CPAC candidate cells (including the second candidate cell). In this case, the stopping condition of the first timer may include that the one or more CPAC candidate cells associated with the first candidate cell meet a condition. In some other implementations, the stopping condition of the first timer may alternatively include that the terminal device acquires a plurality of consecutive out-of-syn indications. For example, the terminal device receives N310 consecutive out-of-syn indications.

In some implementations, if the first time is a time after the first timer stops, accessing the first candidate cell at the first time includes accessing only the first candidate cell at the first time. In other words, if the first timer stops, the terminal device may access only the first candidate cell (that is, execute CHO-only). Certainly, in this embodiment of this application, if the first time is a time after the first timer stops, accessing the first candidate cell at the first time may include accessing the first candidate cell and the second candidate cell at the first time. In other words, if the first timer stops, the terminal device may access the first candidate cell and the second candidate cell.

In this embodiment of this application, whether the terminal device accesses only the first candidate cell or the terminal device accesses both the first candidate cell and the second candidate cell may be determined based on the stopping condition of the first timer. In some implementations, if the stopping condition of the first timer is that the condition of the second candidate cell is met, the terminal device may access the first candidate cell and the second candidate cell after the first timer stops. In some other implementations, in a case in which the condition of the second candidate cell is not met, the terminal device may access only the first candidate cell after the first timer stops. In a case in which the condition of the second candidate cell is not met, the stopping condition of the first timer may include, for example, that an RLF occurs in the source cell, or the stopping condition of the first timer may include, for example, that an RLF-related timer is started. Certainly, in this embodiment of this application, even if the condition of the second candidate cell is met, the terminal device may access only the first candidate cell when the stopping condition of the first timer includes that an RLF-related timer is started and/or that an RLF occurs in the source cell.

In some implementations, the foregoing method further includes: if the first timer expires, the terminal device may execute a CHO-only configuration and/or release an SCG, where the SCG may be a current serving SCG. For example, if a condition of a CPAC candidate cell associated with the first candidate cell is not met during running of the first timer, the terminal device may be handed over to only the first candidate cell based on the CHO-only configuration after the first timer expires. For another example, if a condition of a CPAC candidate cell associated with the first candidate cell is not met during running of the first timer, the terminal device may be handed over to only the first candidate cell based on the CHO-only configuration and release a current serving SCG after the first timer expires.

A granularity of the first timer is not limited in embodiments of this application. In some implementations, the first timer may be associated with each CHO candidate cell (for example, including the first candidate cell). For example, the first timer may be configured and/or maintained for each CHO candidate cell. In some other implementations, the first timer may be associated with a plurality of CHO candidate cells (for example, including the first candidate cell). For example, the first timer may be configured and/or maintained for a plurality of CHO candidate cells, where the plurality of CHO candidate cells may include, for example, some or all of CHO candidate cells in a CHO candidate cell list.

The granularity of the first timer may be used in combination with the starting condition or the restarting condition of the first timer. For example, each CHO candidate cell in a plurality of CHO candidate cells is associated with one first timer. If a condition of a CHO candidate cell is met, a first timer associated with the CHO candidate cell may be started. For another example, a plurality of CHO candidate cells are associated with same one first timer. If a condition of a CHO candidate cell is met, the first timer may be started. If a condition of another CHO candidate cell is met, the first timer may be restarted.

In some implementations, if the condition of the first candidate cell is met, the terminal device may stop evaluating another CHO candidate cell, which is conducive to reducing power consumption required by the terminal device for evaluation. In some implementations, evaluating another CHO candidate cell may include evaluating whether a conditional handover event associated with the another CHO candidate cell is met, or in other words, evaluating another CHO candidate cell may include executing, by the terminal device, a handover condition evaluation task associated with the CHO candidate cell. The another CHO candidate cell is a CHO candidate cell in the plurality of CHO candidate cells of the terminal device other than the first candidate cell.

In some implementations, if the condition of the first candidate cell is met, the terminal device evaluates only the CPAC candidate cell associated with the first candidate cell, which is conducive to reducing power consumption required by the terminal device for evaluation. In some implementations, evaluating a CPAC candidate cell may include evaluating whether a CPAC condition associated with the CPAC candidate cell is met, or in other words, evaluating a CPAC candidate cell may include executing, by the terminal device, a CPAC condition evaluation task associated with the CPAC candidate cell.

As described above, in some embodiments, the terminal device may execute a CHO only for the first candidate cell. To improve reliability of communication between the terminal device and the network device, the terminal device may determine, based on channel quality of a current serving cell (for example, a serving Pcell), whether to execute the CHO only for the first candidate cell. For example, the terminal device may monitor channel quality of the serving Pcell. If the channel quality of the serving Pcell is lower than or equal to a preset threshold, the terminal device executes the CHO only for the first candidate cell. On the contrary, if the channel quality of the serving Pcell is higher than the preset threshold, the terminal device cannot execute the CHO only for the first candidate cell.

In the foregoing implementation, if the terminal device executes the CHO only for the first candidate cell, the terminal device may release the serving SCG. Certainly, in this embodiment of this application, if the terminal device executes the CHO only for the first candidate cell, the terminal device may maintain the serving SCG.

Embodiment 2: The first operation includes accessing, by a terminal device, a first candidate cell.

That is, if a condition of the first candidate cell is met, the terminal device may access the first candidate cell. Whether the first operation includes accessing a second candidate cell is not limited in embodiments of this application. For example, the first operation may include accessing only the first candidate cell. In this case, the terminal device may access only the first candidate cell. For another example, the first operation may include accessing the first candidate cell and the second candidate cell. In this case, the terminal device may access the first candidate cell and the second candidate cell.

In some implementations, if the condition of the first candidate cell is met, the terminal device may stop evaluating another CHO candidate cell, which is conducive to reducing power consumption required by the terminal device for evaluation. In some implementations, evaluating another CHO candidate cell may include evaluating whether a conditional handover event associated with the another CHO candidate cell is met, or in other words, evaluating another CHO candidate cell may include executing, by the terminal device, a handover condition evaluation task associated with the CHO candidate cell. The another CHO candidate cell is a CHO candidate cell in the plurality of CHO candidate cells of the terminal device other than the first candidate cell.

In some implementations, if the condition of the first candidate cell is met, the terminal device may stop evaluating a CPAC candidate cell associated with the first candidate cell, which is conducive to reducing power consumption required by the terminal device for evaluation. In some implementations, evaluating a CPAC candidate cell may include evaluating whether a CPAC condition associated with the CPAC candidate cell is met, or in other words, evaluating a CPAC candidate cell may include executing, by the terminal device, a CPAC condition evaluation task associated with the CPAC candidate cell.

As described above, in some embodiments, the terminal device may execute a CHO only for the first candidate cell. To improve reliability of communication between the terminal device and the network device, the terminal device may determine, based on channel quality of a current serving cell (for example, a serving Pcell), whether to execute the CHO only for the first candidate cell. For example, the terminal device may monitor channel quality of the serving Pcell. If the channel quality of the serving Pcell is lower than or equal to a preset threshold, the terminal device executes the CHO only for the first candidate cell. On the contrary, if the channel quality of the serving Pcell is higher than the preset threshold, the terminal device cannot execute the CHO only for the first candidate cell.

In the foregoing implementation, if the terminal device executes the CHO only for the first candidate cell, the terminal device may release the serving SCG. Certainly, in this embodiment of this application, if the terminal device executes the CHO only for the first candidate cell, the terminal device may maintain the serving SCG.

Embodiment 3: The first operation may include releasing or maintaining, by a terminal device, a serving SCG.

Currently, how to process the serving SCG by the terminal device in the foregoing scenario 1 is not specified in a protocol. It is actually unnecessary to specify that the terminal device releases the serving SCG in a case in which a condition of a first candidate cell is met and a condition of a second candidate cell is not met, which reduces a probability that the terminal device performs communication based on an SCG.

In some scenarios, the serving SCG may be associated with the first candidate cell. For example, the serving SCG belongs to a candidate SCG list associated with the first candidate cell. In this case, even after the terminal device accesses the first candidate cell, the terminal device may perform communication based on the serving SCG. Therefore, in the foregoing case, the terminal device may maintain the serving SCG. That is, if the first operation includes maintaining the serving SCG, the serving SCG belongs to the candidate SCG list. Maintaining the serving SCG may be understood as maintaining a configuration of the serving SCG, and/or maintaining a connection of the serving SCG. Certainly, in an implementation of this application, if the serving SCG is not associated with the first candidate cell, for example, the serving SCG does not belong to the candidate SCG list associated with the first candidate cell, the terminal device may release the serving SCG.

If the terminal device maintains the serving SCG, to improve communication reliability of the terminal device, the serving SCG may be set to an activated state or an inactive state. In some implementations, if a condition of the serving SCG is not met, the terminal device sets the serving SCG to a deactivated state. In some other implementations, if the condition of the serving SCG is met, the terminal device sets the serving SCG to the activated state.

The condition of the serving SCG is not limited in embodiments of this application. In some implementations, the condition of the serving SCG is used to execute a CPAC for the serving SCG, or the condition of the serving SCG may include an addition/change condition associated with the serving SCG. The condition of the serving SCG may be associated with channel quality of the serving SCG. For example, the condition of the serving SCG may include executing an event A4 of the CPAC for the serving SCG.

In some scenarios, to improve communication reliability of the terminal device, the terminal device may determine, based on signal quality of the serving SCG, to maintain the serving SCG or release the serving SCG even if the serving SCG belongs to the candidate SCG list. In some implementations, if the condition of the serving SCG is not met, and the signal quality of the serving SCG is relatively poor (for example, the signal quality of the serving SCG is lower than a threshold), the terminal device may release the serving SCG. In some other implementations, if the condition of the serving SCG is not met, but the signal quality of the serving SCG is relatively good (for example, the signal quality of the serving SCG is higher than the threshold), the terminal device may maintain the serving SCG.

The condition of the serving SCG is not limited in embodiments of this application. In some implementations, the condition of the serving SCG is used to execute the CPAC for the serving SCG, or the condition of the serving SCG may include the addition/change condition associated with the serving SCG. For example, the condition of the serving SCG may include executing an event A3 or an event A5 of the CPAC for the serving SCG. For another example, the condition of the serving SCG may be associated with a measurement configuration of the serving SCG.

For example, assuming that the candidate SCG list is associated with a CHO candidate cell 1, a serving SCG 1 is one SCG in the candidate SCG list, and an execution condition of a CPAC candidate cell includes an event A3. After the CHO candidate cell 1 meets a condition, the terminal device may determine whether a measurement result of the serving SCG 1 meets an RSRP threshold. If the measurement result of the serving SCG 1 meets the RSRP threshold, the terminal device executes a CHO to access the CHO candidate cell, and maintains a connection to the serving SCG 1.

In some implementations, even if the terminal device maintains the serving SCG, because the terminal device is handed over to the first candidate cell, the terminal device may update a configuration of a security key and/or a bearer (for example, an SRB 3) based on a configuration of a candidate cell.

Embodiment 4: The first operation includes evaluating a second candidate cell or stopping evaluating a second candidate cell.

Currently, after a terminal device accesses a first candidate cell, if the terminal device continuously evaluates all CPAC candidate cells of the second candidate cell, power consumption of the terminal device may be increased. If the terminal device evaluates only a CPAC candidate cell associated with the first candidate cell, the terminal device may fail to select a proper SCG, thereby reducing performance of communication between the terminal device and a network device. Therefore, for the foregoing problem, an embodiment of this application further provides a determining manner, which is described below with reference to examples 1 to 3.

Example 1: A terminal device may determine, based on first information, to evaluate a second candidate cell or to stop evaluating the second candidate cell, or in other words, the first information is used to indicate, to the terminal device, evaluating the second candidate cell or stopping evaluating the second candidate cell. In this case, the first information may also be referred to as “first indication information”. That is, the first information may be used to indicate, to the terminal device, evaluating the second candidate cell or stopping evaluating the second candidate cell through explicit signalling.

A manner of carrying the first information is not limited in embodiments of this application. In some implementations, the first information may be carried in configuration information of the first candidate cell. Certainly, in this embodiment of this application, the first information may alternatively be information transmitted separately.

In some implementations, the terminal device may stop evaluating a CPAC candidate cell. In this case, the terminal device may maintain a condition of the CPAC candidate cell, to facilitate evaluation of the CPAC candidate cell next time, thereby reducing transmission overheads required for transmitting the condition of the CPAC candidate cell. Certainly, in this embodiment of this application, if the terminal device stops evaluating the CPAC candidate cell, the terminal device may release a configuration of the CPAC candidate cell. The configuration of the CPAC candidate cell may include, for example, an execution condition configuration of the CPAC candidate cell, and/or the configuration of the CPAC candidate cell may include, for example, a candidate cell configuration of the CPAC candidate cell.

In addition, in this embodiment of this application, if the terminal device stops evaluating the CPAC candidate cell, the terminal device may restart evaluation of the CPAC candidate cell based on an indication of indication information. The indication information may be, for example, a message (for example, an RRC message) used to update or configure a CPAC evaluation condition.

For example, if a configuration of a CHO candidate cell 1 includes the first information, the first information is used to indicate evaluating the second candidate cell. Correspondingly, when applying the configuration of the CHO candidate cell 1, the terminal device may evaluate, based on an addition/change condition included in the configuration of the CHO candidate cell 1, a CPAC candidate cell associated with the CHO candidate cell 1.

For another example, if the CHO candidate cell 1 includes the first information, the first information is used to indicate stopping evaluating the second candidate cell. Correspondingly, when applying the configuration of the CHO candidate cell 1, the terminal device may stop evaluating the CPAC candidate cell associated with the CHO candidate cell 1. Then, if the terminal device receives an RRC message that is transmitted by the CHO candidate cell 1 and that is used to update or configure a CPAC evaluation condition, the terminal device may restart evaluation of the CPAC candidate cell.

In some implementations, if the first information indicates stopping evaluating the second candidate cell, the first information is further used to determine to release or maintain a CPAC configuration of the second candidate cell. Certainly, in this embodiment of this application, information used to determine to release or maintain the CPAC configuration information of the second candidate cell may alternatively be other information than the first information.

A manner of determining, based on the first information, to release or maintain the CPAC configuration of the second candidate cell is not limited in embodiments of this application. For example, if the first information exists, it may be determined to maintain the CPAC configuration of the second candidate cell. For another example, if the first information does not exist, it may be determined to release the CPAC configuration of the second candidate cell. For another example, the first information may be used to indicate releasing or maintaining the CPAC configuration of the second candidate cell.

For example, if the CHO candidate cell 1 includes the first information, the first information is used to indicate stopping evaluating the CPAC candidate cell associated with the CHO candidate cell 1. Correspondingly, when applying the configuration of the CHO candidate cell 1, the terminal device may maintain a configuration (for example, an execution condition configuration related to the CPAC candidate cell in a first UE variable and/or a CPAC candidate cell configuration in a second UE variable) of the CPAC candidate cell associated with the CHO candidate cell 1.

For another example, if a configuration of a target CHO candidate cell does not include the first indication information, the first information is used to indicate stopping evaluating the CPAC candidate cell associated with the CHO candidate cell 1. Correspondingly, the terminal device applies the configuration of the CHO candidate cell 1 and releases a CPAC configuration (for example, the execution condition configuration related to the CPAC candidate cell in the first UE variable and/or the CPAC candidate cell configuration in the second UE variable).

Example 2: A terminal device may determine, based on first information, to evaluate a second candidate cell or to stop evaluating the second candidate cell, where the first information is used to determine validity of a condition (including a condition of the second candidate cell) of a CPAC candidate cell associated with a first candidate cell.

In some implementations, the validity of the condition of the CPAC candidate cell may be determined based on a node that configures the condition of the CPAC candidate cell. That is, the first information is used to indicate a node that configures the condition of the CPAC candidate cell, and the node includes one or more of a source MN, a source SN, a candidate MN, or a candidate SN.

In some implementations, if the first information indicates that the node is the source MN, the terminal device stops evaluating the CPAC candidate cell. That is, in a case in which the condition of the CPAC candidate cell is configured by the source MN, if the terminal device is handed over to the first candidate cell (that is, after a primary cell changes), the condition of the CPAC candidate cell is invalid, and the terminal device may stop evaluating the CPAC candidate cell.

In this embodiment of this application, if the condition of the CPAC candidate cell is configured by the source MN, the condition of the CPAC candidate cell is associated with an MCG measurement configuration.

In some implementations, if the first information indicates that the node is the candidate MN, and the terminal device is handed over to the candidate MN, the terminal device evaluates the CPAC candidate cell. That is, in a case in which the condition of the CPAC candidate cell is configured by the candidate MN, if the terminal device is handed over to the candidate MN, the condition of the CPAC candidate cell is valid, and the terminal device may continue to evaluate the CPAC candidate cell.

In some implementations, if the first information indicates that the node is the source SN, and the terminal device is handed over to the first candidate cell and maintains the source SN, the terminal device evaluates the CPAC candidate cell. That is, in a case in which the condition of the CPAC candidate cell is configured by the source SN, if the terminal device is handed over to the candidate MN and maintains the source SN, the condition of the CPAC candidate cell is valid, and the terminal device may continue to evaluate the CPAC candidate cell.

In some implementations, if the first information indicates that the node is the source SN, and the terminal device is handed over to the first candidate cell and releases a source SCG (or in other words, an SCG handover occurs), the terminal device stops evaluating the CPAC candidate cell. That is, in a case in which the condition of the CPAC candidate cell is configured by the source SN, if the terminal device is handed over to the candidate MN and releases the source SN, the condition of the CPAC candidate cell is invalid, and the terminal device may stop evaluating the CPAC candidate cell.

In some implementations, if the first information indicates that the node is the candidate SN (also referred to as a “target SN”), the terminal device evaluates the CPAC candidate cell. That is, in a case in which the condition of the CPAC candidate cell is configured by the candidate SN, if the terminal device is handed over to the candidate SN, the condition of the CPAC candidate cell is valid, and the terminal device may continue to evaluate the CPAC candidate cell.

Example 3: A terminal device may determine, based on first information, to evaluate a second candidate cell or to stop evaluating the second candidate cell, where the first information is used to indicate a node that triggers a CPAC based on the second candidate cell, and the node includes one or more of a source MN, a source SN, or a candidate MN.

In some implementations, if the first information indicates that the node is the source MN, the terminal device stops evaluating a CPAC candidate cell. That is, in a case in which the CPAC is triggered by the source MN, if the terminal device is handed over to a first candidate cell (that is, after a primary cell changes), the terminal device may stop evaluating the CPAC candidate cell.

In some implementations, if the first information indicates that the node is the candidate MN, and the terminal device is handed over to the candidate MN, the terminal device evaluates the CPAC candidate cell. That is, in a case in which the CPAC is triggered by the candidate MN, if the terminal device is handed over to the candidate MN, the terminal device may continue to evaluate the CPAC candidate cell. Otherwise, the terminal device stops evaluating the CPAC candidate cell.

In some implementations, if the first information indicates that the node is the source SN, and the terminal device is handed over to the first candidate cell and maintains the source SN, the terminal device evaluates the CPAC candidate cell. That is, in a case in which the CPAC is configured by the source SN, if the terminal device is handed over to the candidate MN and maintains the source SN, the terminal device may continue to evaluate the CPAC candidate cell. Otherwise, the terminal device stops evaluating the CPAC candidate cell.

In some implementations, if the first information indicates that the node is the source SN, and the terminal device is handed over to the first candidate cell and releases the source SN (or in other words, an SCG handover occurs), the terminal device stops evaluating the CPAC candidate cell. That is, in a case in which the CPAC is triggered by the source SN, if the terminal device is handed over to the candidate MN and releases the source SN, the terminal device may stop evaluating the CPAC candidate cell.

In this embodiment of this application, that the terminal device may stop evaluating the CPAC candidate cell may include: the terminal device stops evaluating the CPAC candidate cell until a new CPAC execution condition is determined, or in other words, the terminal device does not execute evaluation of the CPCA candidate cell before the new CPAC execution condition is determined.

It should be noted that in this embodiment of this application, if the terminal device stops evaluating the CPAC candidate cell, the terminal device may maintain a condition of the CPAC candidate cell, to facilitate evaluation of the CPAC candidate cell next time, thereby reducing transmission overheads required for transmitting the condition of the CPAC candidate cell. Certainly, in this embodiment of this application, if the terminal device stops evaluating the CPAC candidate cell, the terminal device may discard the condition of the CPAC candidate cell.

In addition, in this embodiment of this application, if the terminal device stops evaluating the CPAC candidate cell, the terminal device may restart evaluation of the CPAC candidate cell based on an indication of indication information. The indication information may be, for example, a message (for example, an RRC message) used to update or configure a CPAC evaluation condition.

In some implementations, if an SCG handover occurs, before determining a new CPAC execution condition, the terminal device may not execute evaluation on the CPAC candidate cell. The new CPAC execution condition may include that a candidate SCG or a target SCG configures a new evaluation condition for the terminal device.

In some implementations, if the terminal device does not execute evaluation on the CPAC candidate cell, the terminal device may release a CPAC configuration. Certainly, in this embodiment of this application, if the terminal device does not execute evaluation on the CPAC candidate cell, the terminal device may maintain the CPAC configuration.

Embodiment 5: The first operation includes evaluating a first candidate cell or stopping evaluating the first candidate cell.

Currently, after a terminal device accesses the first candidate cell and/or a second candidate cell, if the terminal device continuously evaluates the first candidate cell, power consumption of the terminal device may be increased. If the terminal device stops evaluating the first candidate cell, reliability of communication between the terminal device and a network device may be reduced. Therefore, for the foregoing problem, an embodiment of this application further provides a determining manner.

In some implementations, the terminal device may determine, based on first information, to evaluate the first candidate cell or to stop evaluating the first candidate cell, or in other words, the first information is used to indicate, to the terminal device, evaluating the first candidate cell or stopping evaluating the first candidate cell. In this case, the first information may also be referred to as “first indication information”. That is, the first information may be used to indicate, to the terminal device, evaluating the first candidate cell or stopping evaluating the first candidate cell through explicit signalling.

A manner of carrying the first information is not limited in embodiments of this application. In some implementations, the first information may be carried in configuration information of the first candidate cell. Certainly, in this embodiment of this application, the first information may alternatively be information transmitted separately.

It should be noted that, in this embodiment of this application, the first candidate cell belongs to a CHO candidate cell. Correspondingly, evaluating the first candidate cell may be replaced with evaluating the CHO candidate cell, and stopping evaluating the first candidate cell may be replaced with stopping evaluating the CHO candidate cell.

Embodiment 6: The first operation includes camping on a source cell.

In some scenarios, signal quality of the source cell may be relatively good. For example, the signal quality of the source cell is higher than a threshold. In this case, a terminal device may execute the first operation, that is, camp on the source cell, to prevent unnecessary handovers.

In some other scenarios, signal quality of a first candidate cell may be relatively poor. For example, the signal quality of the first candidate cell is lower than a threshold. In this case, the terminal device may execute the first operation, that is, camp on the source cell, to prevent unnecessary handovers.

In some implementations, a time at which the first operation is executed may be determined based on a third timer. For example, the first operation is executed after the third timer stops. For another example, the time at which the first operation is executed may be a stopping time of the third timer.

In some implementations, a stopping condition of the third timer may be associated with the signal quality of the first candidate cell and/or the signal quality of the source cell. The signal quality of the first candidate cell is used as an example. In this case, the stopping condition may include that the signal quality of the first candidate cell is lower than a threshold. The signal quality of the source cell is used as an example. In this case, the stopping condition may include that the signal quality of the source cell is higher than a threshold.

It should be noted that, in this embodiment of this application, to improve accuracy of executing the first operation, the stopping condition may be based on the signal quality of the source cell and the signal quality of the first candidate cell. For example, the stopping condition may include that the signal quality of the first candidate cell is lower than a first threshold, and the stopping condition may include that the signal quality of the source cell is higher than a second threshold. The first threshold and the second threshold may be a same threshold, or may be different thresholds. This is not limited in embodiments of this application.

In some implementations, a starting condition of the third timer may be the same as a starting condition of a first timer. In some implementations, the starting condition or a restarting condition of the third timer includes that a condition of the first candidate cell is met, that is, the terminal device starts or restarts the third timer in response to that the condition of the first candidate cell is met.

In some other implementations, a restarting condition of the first timer includes that a condition of a third candidate cell is met during running of the third timer, where the third candidate cell is a CHO-based candidate cell (also referred to as a “CHO candidate cell”) other than the first candidate cell. A quantity of third candidate cells is not limited in embodiments of this application, and the third candidate cell may include one or more CHO candidate cells.

For example, in response to that a condition of a CHO candidate cell 1 is met, the terminal device starts the third timer, and evaluates another CHO candidate cell during running of the third timer. In this case, if a condition of a CHO candidate cell 2 is met, the terminal device may restart the third timer.

It should be noted that the foregoing embodiments may be used separately, or may be used in combination with each other. For example, Embodiment 3 may be used in combination with Embodiment 1. Based on the descriptions in Embodiment 3, if the terminal device releases an SCG, the terminal device may determine, based on the solution in Embodiment 1, an occasion for accessing the first candidate cell.

Scenario 2: A time at which a condition of a second candidate cell is met is different from a time at which a condition of a first candidate cell is met. For ease of description, in the following, the time at which the condition of the second candidate cell is met is referred to as a “time 1”, and the time at which the condition of the first candidate cell is met is referred to as a “time 2”.

A sequence relationship between the time 1 and the time 2 is not limited in embodiments of this application. For example, the time 1 may be earlier than the time 2, that is, the condition of the second candidate cell is already met before the time at which the condition of the first candidate cell is met. For example, the time 1 may be later than time 2, that is, the condition of the first candidate cell is already met before the time at which the condition of the second candidate cell is met.

In addition, for related descriptions of the first candidate cell, the second candidate cell, a relationship between the first candidate cell and the second candidate cell, the condition of the first candidate cell, the condition of the second candidate cell, and the like, reference is made to related descriptions in the scenario 1. Descriptions corresponding to a same term are similar. For brevity, details are not described herein again.

In some implementations, in the scenario 2, a terminal device accesses the first candidate cell at a second time. The second time may be determined based on the time (that is, the time 2) at which the condition of the first candidate cell is met.

That the second time may be determined based on the time 2 may be understood as: the second time may be a time period after the time 2, or the second time may be equal to the time 2. That is, the time at which the terminal device accesses the first candidate cell may be later than the time at which the condition of the first candidate cell is met, or the time at which the terminal device accesses the first candidate cell may be set to the time at which the condition of the first candidate cell is met.

That the terminal device accesses the first candidate cell at the second time may be replaced with: the terminal device accesses the first candidate cell in response to that the condition of the first candidate cell is met. For example, the time 1 is earlier than the time 2. In a case in which the condition of the second candidate cell is met, the terminal device accesses the first candidate cell in response to that the condition of the first candidate cell is met.

Meeting the condition of the first candidate cell is not limited in embodiments of this application. In some implementations, meeting the condition of the first candidate cell may be understood as: the condition of the first candidate cell is met after being relaxed, or in other words, the relaxed condition of the first candidate cell is met, or in other words, the condition of the first candidate cell is met after measurement for the first candidate cell is relaxed. Correspondingly, the time at which the condition of the first candidate cell is met may be determined based on a time corresponding to that the relaxed condition of the first candidate cell is met. In other words, the terminal device accesses the first candidate cell in response to that the relaxed condition of the first candidate cell is met.

In some implementations, the terminal device generally monitors a channel condition of the first candidate cell, to determine whether the condition of the first candidate cell is met, and the terminal device can access the first candidate cell only when the condition of the first candidate cell is always met within a predefined time period (for example, a time-to-trigger TTT). Correspondingly, in this embodiment of this application, relaxing the measurement for the first candidate cell may include skipping measuring the channel condition of the first candidate cell within the predefined time period, or in other words, may include not needing to measure the condition of the first candidate cell within the predefined time period, or in other words, may include adjusting duration of the predefined time period to 0.

Certainly, in this embodiment of this application, relaxing the measurement for the first candidate cell may further include shortening the duration of the predefined time period. For example, after the measurement for the first candidate cell is relaxed, duration of a TTT associated with the first candidate cell is less than an original TTT associated with the first candidate cell, where the original TTT is a TTT used before the measurement for the first candidate cell is relaxed.

For example, a CHO candidate cell 1 is associated with a CPAC candidate cell 1. If the CHO candidate cell 1 meets an entering condition, the CHO candidate cell 1 needs to be continuously measured within a TTT 3 corresponding to the CHO candidate cell 1, to determine that the CHO candidate cell 1 meets the condition within the TTT 3. Only when the CHO candidate cell 1 meets the condition within the TTT 3, it may be considered that the CHO candidate cell 1 meets the condition.

However, by using the solution in this embodiment of this application, a condition of the CHO candidate cell 1 may be relaxed. In a case in which the CHO candidate cell 1 meets the entering condition, the CHO candidate cell 1 can be directly accessed without determining whether the condition of the CHO candidate cell 1 is met within the TTT 3.

For another example, after the second candidate cell meets the condition, the terminal device may evaluate the first candidate cell. If the first candidate cell meets the entering condition, it is considered that the condition of the first candidate cell is met.

In some other implementations, the condition of the first candidate cell may be associated with a threshold. Correspondingly, the relaxed condition of the first candidate cell may include a reduced threshold.

For example, the condition of the first candidate cell includes that if a measurement result of the first candidate cell is greater than a threshold value 1, the condition of the first candidate cell is met. Correspondingly, in this embodiment of this application, the relaxed condition of the first candidate cell is used to indicate that if the measurement result of the first candidate cell is greater than a threshold value 2, the condition of the first candidate cell is met, where the threshold value 1 is greater than the threshold value 2.

Certainly, in this embodiment of this application, the condition of the first candidate cell may alternatively be relaxed in another manner. In some implementations, the condition of the first candidate cell may be relaxed by adjusting the measurement result of the first candidate cell. For example, the condition of the first candidate cell includes that if a difference between the measurement result of the first candidate cell and a preset parameter 1 is greater than a threshold value, the condition of the first candidate cell is met. Correspondingly, in this embodiment of this application, the relaxed condition of the first candidate cell is used to indicate that if a difference between the measurement result of the first candidate cell and a preset parameter 2 is greater than a threshold value, the condition of the first candidate cell is met, where the preset parameter 1 is greater than the preset parameter 2.

A manner of adjusting a preset parameter is not limited in embodiments of this application. In addition to relaxing the condition of the first candidate cell by reducing a preset parameter that is described above, in some implementations, the condition of the first candidate cell may alternatively be relaxed by increasing a preset parameter. For example, if the condition of the first candidate cell includes an event A3 (CondEvent A3), the condition of the first candidate cell may be relaxed by increasing a preset parameter.

It should be noted that in this embodiment of this application, when accessing the first candidate cell, the terminal device may further access the second candidate cell, that is, execute a CHO for the first candidate cell and a CPAC for the second candidate cell. Certainly, the terminal device may alternatively not access the second candidate cell.

In some implementations, the second time is associated with a second timer. In some implementations, a stopping time of the second timer may be the second time, or the second time may be a time after the second timer stops.

In some implementations, the second timer is used to indicate duration of evaluating the first candidate cell, that is, the first candidate cell may be evaluated based on the relaxed condition of the first candidate cell during running of the second timer.

A starting condition of the second timer is not limited in embodiments of this application. In some implementations, the starting condition of the second timer includes one or more of the following: the condition of the first candidate cell is met; the condition of the second candidate cell is met; a condition of a fifth candidate cell associated with the first candidate cell is not met; or a condition of a fourth candidate cell associated with the second candidate cell is not met.

For example, the starting condition includes that the condition of the first candidate cell is met. That is, the terminal device starts the second timer in response to that the condition of the first candidate cell is met.

For example, the starting condition includes that the condition of the second candidate cell is met. That is, the terminal device starts the second timer in response to that the condition of the second candidate cell is met.

For example, the starting condition includes that the condition of the fifth candidate cell associated with the first candidate cell is not met, where the fifth candidate cell is a CPAC candidate cell, for example, the fifth candidate cell may include the second candidate cell. That is, the terminal device starts the second timer in response to that the condition of the fifth candidate cell is not met.

A quantity of fifth candidate cells is not limited in embodiments of this application, and the fifth candidate cell may include one or more CPAC candidate cells.

For example, the starting condition includes that the condition of the fourth candidate cell associated with the second candidate cell is not met, where the fourth candidate cell is a CHO candidate cell, for example, the fourth candidate cell may include the first candidate cell. That is, the terminal device starts the second timer in response to that the condition of the fourth candidate cell is not met.

A quantity of fourth candidate cells is not limited in embodiments of this application, and the fourth candidate cell may include one or more CHO candidate cells.

A stopping condition of the second timer is not limited in embodiments of this application. In some implementations, the stopping condition of the second timer includes that the condition of the first candidate cell is met and/or that the condition of the second candidate cell is met. For example, the stopping condition of the second timer may include that the first candidate cell meets the condition, and the second candidate cell associated with the first candidate cell meets the condition.

In some implementations, if the second timer expires, the foregoing method further includes: executing, by the terminal device, one or more of the following operations: executing a CHO for the first candidate cell by the terminal device; restarting evaluation of candidate cells of the terminal device; executing a CHO and a CPAC for a target candidate cell and another candidate cell associated with the target candidate cell; or executing a CHO and a CPAC for the target candidate cell and another candidate cell associated with the target candidate cell, where a condition of CPAC for the target candidate cell is met.

For example, the operation includes executing a CHO for the first candidate cell. If the second timer expires, the terminal device may execute the CHO only for the first candidate cell.

For example, the operation includes restarting evaluation of the candidate cells of the terminal device. If the second timer expires, the terminal device may restart evaluation of some or all of the candidate cells. The candidate cells may include a CHO candidate cell and/or a CPAC candidate cell, where the CHO candidate cell may include the first candidate cell, and the CPAC candidate cell may include the second candidate cell.

In addition, evaluating a candidate cell may include evaluating whether at least one of a conditional handover event associated with the candidate cell or a CPAC condition associated with the candidate cell is met, or in other words, evaluating a candidate cell may include executing, by the terminal device, a conditional handover event evaluation task associated with the candidate cell and/or a CPAC condition evaluation task associated with the candidate cell.

For example, the operation includes executing a CHO and a CPAC for the target candidate cell and another candidate cell associated with the target candidate cell, where a condition of CHO for the target candidate cell is met. That is, the terminal device may select a CHO candidate cell that meets a condition, and execute a CHO and a CPAC for the CHO candidate cell and a CPAC candidate cell associated with the CHO candidate cell.

It should be noted that a manner in which the terminal device selects a CHO candidate cell that meets the condition is not limited in embodiments of this application. For example, the terminal device may select, based on a preset rule, a CHO candidate cell that meets the condition, where the preset rule is used to indicate selecting a CHO candidate cell with the best signal quality, which is conducive to improving quality of communication between the terminal device and a network device. For another example, the terminal device may randomly select a CHO candidate cell that meets the condition, to simplify complexity of selecting, by the terminal device, a CHO candidate cell that meets the condition.

For example, the operation includes executing a CHO and a CPAC for the target candidate cell and another candidate cell associated with the target candidate cell, where a condition of CPAC for the target candidate cell is met. That is, the terminal device may select a CPAC candidate cell that meets a condition, and execute a CHO and a CPAC for the CPAC candidate cell and a CHO candidate cell associated with the CPAC candidate cell.

It should be noted that a manner in which the terminal device selects a CPAC candidate cell that meets the condition is not limited in embodiments of this application. For example, the terminal device may select, based on a preset rule, a CPAC candidate cell that meets the condition, where the preset rule is used to indicate selecting a CPAC candidate cell with the best signal quality, which is conducive to improving quality of communication between the terminal device and a network device. For another example, the terminal device may randomly select a CPAC candidate cell that meets the condition, to simplify complexity of selecting, by the terminal device, a CPAC candidate cell that meets the condition.

It should be noted that, in the foregoing descriptions, the evaluating the first candidate cell may include evaluating whether a conditional handover event associated with the first candidate cell is met, or in other words, the evaluating the first candidate cell may include executing, by the terminal device, a conditional handover event evaluation task associated with the first candidate cell.

In addition, the evaluating the second candidate cell may include evaluating whether a CPAC condition associated with the second candidate cell is met, or in other words, the evaluating the second candidate cell may include executing, by the terminal device, a CPAC condition evaluation task associated with the second candidate cell.

It should be noted that in this embodiment of this application, the CHO candidate cell may include the first candidate cell, and the CHO candidate cell may be a CHO candidate cell in CHO candidate cells of the terminal device other than the first candidate cell.

In this embodiment of this application, the CPAC candidate cell may include the second candidate cell, and the CPAC candidate cell may be a CPAC candidate cell in CPAC candidate cells of the terminal device other than the second candidate cell.

The foregoing describes the method embodiments of this application in detail with reference to FIG. 1 to FIG. 4. The following describes the apparatus embodiments of this application in detail with reference to FIG. 5 to FIG. 7. It should be understood that the descriptions of the method embodiments correspond to descriptions of the apparatus embodiments, and therefore, for parts that are not described in detail, refer to the foregoing method embodiments.

FIG. 5 is a schematic diagram of a terminal device according to an embodiment of this application. The terminal device 500 in FIG. 5 includes a processing unit 510.

If a condition of a first candidate cell is met and a condition of a second candidate cell is not met, the processing unit 510 is configured to execute a first operation, where the first candidate cell is a conditional handover CHO candidate cell, the second candidate cell is a conditional primary secondary cell addition/change CPAC candidate cell, and the first candidate cell is associated with the second candidate cell; and the first operation includes one or more of the following: accessing the first candidate cell at a first time; accessing the first candidate cell; releasing or maintaining a serving secondary cell group SCG; evaluating the second candidate cell; stopping evaluating the second candidate cell; evaluating the first candidate cell; stopping evaluating the first candidate cell; or camping on a source cell.

In a possible implementation, if the first operation includes accessing the first candidate cell at the first time, the first time is determined based on a time at which the condition of the second candidate cell; or the first time is independent of the time at which the condition of the second candidate cell is met.

In a possible implementation, if the first time is determined based on the time at which the condition of the second candidate cell is met, the time at which the condition of the second candidate cell is met is determined based on a time at which a target condition of the second candidate cell is met, and the target condition is obtained by relaxing the condition of the second candidate cell.

In a possible implementation, if the first operation includes accessing the first candidate cell at the first time, the first time is associated with a first timer, and the first timer is used to indicate duration of evaluating the second candidate cell.

In a possible implementation, a starting condition of the first timer includes that the condition of the first candidate cell is met.

In a possible implementation, a restarting condition of the first timer includes that a condition of a third candidate cell is met during running of the first timer, and the third candidate cell is a CHO-based candidate cell other than the first candidate cell.

In a possible implementation, the stopping condition of the first timer includes one or more of the following: the condition of the shown in second candidate cell is met; a measurement result of a source cell of the terminal device is lower than a threshold; a radio link failure RLF occurs in the source cell of the terminal device; or an RLF-related timer is started.

In a possible implementation, if the first time is a time after the first timer stops, the accessing the first candidate cell at the first time includes accessing only the first candidate cell at the first time.

In a possible implementation, the processing unit is further configured to: if the first timer expires, release an SCG.

In a possible implementation, if the first operation includes maintaining the serving SCG, the serving SCG belongs to a candidate SCG list.

In a possible implementation, a condition of the serving SCG is used to execute a CPC based on the serving SCG, and the processing unit is further configured to: if the condition of the serving SCG is not met, set the serving SCG to a deactivated state; and/or if the condition of the serving SCG is met, set the serving SCG to an activated state.

In a possible implementation, if the first operation includes releasing the serving SCG, the serving SCG does not belong to a candidate SCG list.

In a possible implementation, if the first operation includes evaluating the second candidate cell or stopping evaluating the second candidate cell, the processing unit is further configured to: determine, based on first information, to evaluate the second candidate cell or to stop evaluating the second candidate cell.

In a possible implementation, the first information is used to indicate evaluating the second candidate cell or stopping evaluating the second candidate cell.

In a possible implementation, if the first information indicates stopping evaluating the second candidate cell, the first information is further used to determine to release or maintain a CPAC configuration of the second candidate cell.

In a possible implementation, the first information is used to indicate a node that configures the condition of the second candidate cell, and the node includes one or more of a source MN, a source SN, a candidate MN, or a candidate SN.

In a possible implementation, if the first information indicates that the node is the source MN, the terminal device stops evaluating the second candidate cell; and/or if the first information indicates that the node is the candidate MN, and the terminal device is handed over to the candidate MN, the terminal device evaluates the second candidate cell; and/or if the first information indicates that the node is the source SN, and the terminal device is handed over to the first candidate cell and maintains the source SN, the terminal device evaluates the second candidate cell; and/or if the first information indicates that the node is the candidate SN, the terminal device evaluates the second candidate cell.

In a possible implementation, the first information is used to indicate a node used to trigger a CPAC associated with the second candidate cell, and the node includes one or more of a source MN, a source SN, or a candidate MN.

In a possible implementation, if the first information indicates that the node is the source MN, the terminal device stops evaluating the second candidate cell; and/or if the first information indicates that the node is the candidate MN, and the terminal device is handed over to the candidate MN, the terminal device evaluates the second candidate cell; and/or if the first information indicates that the node is the source SN, and the terminal device is handed over to the first candidate cell and maintains the source SN, the terminal device evaluates the second candidate cell; and/or if the first information indicates that the node is the source SN, and the terminal device is handed over to the first candidate cell and releases the source SN, the terminal device stops evaluating the second candidate cell.

In a possible implementation, if the first operation includes camping on the source cell, and the first operation is executed after a third timer stops, a stopping condition of the third timer includes: signal quality of the first candidate cell is lower than a threshold; and/or signal quality of the source cell of the terminal device is higher than a threshold.

FIG. 6 is a schematic diagram of a terminal device according to an embodiment of this application. The terminal device 600 shown in FIG. 6 includes a processing unit 610.

If a time at which a condition of a second candidate cell is met is different from a time at which a condition of a first candidate cell is met, the processing unit 610 is configured to access the first candidate cell at a second time, where the first candidate cell is a conditional handover CHO candidate cell, the second candidate cell is a conditional primary secondary cell addition/change CPAC candidate cell, and the first candidate cell is associated with the second candidate cell.

In a possible implementation, the second time is determined based on the time at which the condition of the first candidate cell is met.

In a possible implementation, the time at which the condition of the first candidate cell is met is determined based on a time at which a target condition of the first candidate cell is met, and the target condition is obtained by relaxing the condition of the first candidate cell.

In a possible implementation, the second time is associated with a second timer, and the second timer is used to indicate duration of evaluating the first candidate cell.

In a possible implementation, a starting condition of the second timer includes one or more of the following: the condition of the first candidate cell is met; the condition of the second candidate cell is met; a condition of a fifth candidate cell associated with the first candidate cell is not met, where the fifth candidate cell is a CPAC candidate cell; or a condition of a fourth candidate cell associated with the second candidate cell is not met, where the fourth candidate cell is a CHO candidate cell.

In a possible implementation, a stopping condition of the second timer includes that the condition of the first candidate cell is met or the condition of the second candidate cell is met.

In a possible implementation, the second time is a time after the second timer stops.

In some implementations, if the second timer expires, the processing unit is further configured to: execute, by the terminal device, one or more of the following operations: a CHO for the first candidate cell; restarting evaluation of a candidate cell of the terminal device; executing a CHO and a CPAC for a target candidate cell and another candidate cell associated with the target candidate cell, where a condition of CHO for the target candidate cell is met; or executing a CHO and a CPAC for a target candidate cell and another candidate cell associated with the target candidate cell, where a condition of CPAC for the target candidate cell is met.

In an optional embodiment, the processing unit 510 may be a processor 710. The terminal device 500 may further include a transceiver 730 and a memory 720, which are specifically shown in FIG. 7.

In an optional embodiment, the processing unit 610 may be a processor 710. The terminal device 600 may further include a transceiver 730 and a memory 720, which are specifically shown in FIG. 7.

FIG. 7 is a schematic structural diagram of a communications apparatus according to an embodiment of this application. Dashed lines in FIG. 7 indicate that units or modules are optional. The apparatus 700 may be configured to implement the methods described in the method embodiments. The apparatus 700 may be a chip, a terminal device, or a network device.

The apparatus 700 may include one or more processors 710. The processor 710 may support the apparatus 700 in implementing the methods described in the method embodiments. The processor 710 may be a general-purpose processor or a dedicated processor. For example, the processor may be a central processing unit (CPU). Alternatively, the processor may be another general-purpose processor, a digital signal processor (DSP), an application specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The apparatus 700 may further include one or more memories 720. The memory 720 stores a program, where the program may be executed by the processor 710, to cause the processor 710 to execute the methods described in the method embodiments. The memory 720 may be separate from the processor 710 or may be integrated into the processor 710.

The apparatus 700 may further include a transceiver 730. The processor 710 may communicate with another device or chip by using the transceiver 730. For example, the processor 710 may transmit data to and receive data from another device or chip through the transceiver 730.

An embodiment of this application further provides a computer-readable storage medium, configured to store a program. The computer-readable storage medium may be applied to a terminal or a network device provided in embodiments of this application, and the program causes a computer to execute the methods to be executed by the terminal or the network device in various embodiments of this application.

An embodiment of this application further provides a computer program product. The computer program product includes a program. The computer program product may be applied to a terminal or a network device provided in embodiments of this application, and the program causes a computer to execute the methods to be executed by the terminal or the network device in various embodiments of this application.

An embodiment of this application further provides a computer program. The computer program may be applied to a terminal or a network device provided in embodiments of this application, and the computer program causes a computer to execute the methods to be executed by the terminal or the network device in various embodiments of this application.

It should be understood that the terms “system” and “network” in this application may be used interchangeably. In addition, the terms used in this application are only used to illustrate specific embodiments of this application, but are not intended to limit this application. The terms “first”, “second”, “third”, “fourth”, and the like in the specification, claims, and accompanying drawings of this application are used for distinguishing different objects from each other, rather than defining a specific order. In addition, the terms “include” and “have” and any variations thereof are intended to cover a non-exclusive inclusion.

The “indication” mentioned in embodiments of this application may be a direct indication or an indirect indication, or indicate an association relationship. For example, if A indicates B, it may mean that A directly indicates B, for example, B may be acquired from A. Alternatively, it may mean that A indicates B indirectly, for example, A indicates C, and B may be acquired from C. Alternatively, it may mean that there is an association between A and B.

In embodiments of this application, “B corresponding to A” means that B is associated with A, and B may be determined based on A. However, it should be further understood that determining B based on A does not mean determining B based on only A, but instead B may be determined based on A and/or other information.

In embodiments of this application, the term “corresponding” may mean that there is a direct or indirect correspondence between two elements, or that there is an association relationship between two elements, or that there is a relationship of “indicating” and “being indicated”, “configuring” and “being configured”, or the like.

In embodiments of this application, “pre-defining” or “pre-configuring” may be implemented by pre-storing corresponding code or a corresponding table in a device (for example, including a terminal device and a network device) or in other manners that may be used for indicating related information. A specific implementation thereof is not limited in this application. For example, pre-defining may indicate being defined in a protocol.

In embodiments of this application, the “protocol” may indicate a standard protocol in the communications field, which may include, for example, an LTE protocol, an NR protocol, and a related protocol applied to a future communications system. This is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” herein generally indicates an “or” relationship between the associated objects.

In embodiments of this application, sequence numbers of the foregoing processes do not mean execution orders. The execution orders of the processes should be determined based on functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, and may be at one location, or may be distributed on a plurality of network elements. Some or all of the units may be selected according to actual requirements to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions in embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, radio, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A method for wireless communication, comprising:
executing, by a terminal device, a first operation if a condition of a first candidate cell is met and a condition of a second candidate cell is not met,
wherein the first candidate cell is a conditional handover (CHO) candidate cell, the second candidate cell is a conditional primary secondary cell addition/change (CPAC) candidate cell, and the first candidate cell is associated with the second candidate cell; and
the first operation comprises one or more of following:
accessing the first candidate cell at a first time;
accessing the first candidate cell;
releasing or maintaining a serving secondary cell group (SCG);
evaluating the second candidate cell;
stopping evaluating the second candidate cell;
evaluating the first candidate cell;
stopping evaluating the first candidate cell; or
camping on a source cell.

2. The method according to claim 1, wherein if the first operation comprises accessing the first candidate cell at the first time, the first time is determined based on a time at which the condition of the second candidate cell is met, or
the first time is independent of a time at which the condition of the second candidate cell is met.

3. The method according to claim 2, wherein if the first time is determined based on the time at which the condition of the second candidate cell is met, the time at which the condition of the second candidate cell is met is determined based on a time at which a target condition of the second candidate cell is met, and the target condition is obtained by relaxing the condition of the second candidate cell.

4. The method according to claim 1, wherein if the first operation comprises accessing the first candidate cell at the first time, the first time is associated with a first timer, and the first timer is used to indicate duration of evaluating the second candidate cell.

5. The method according to claim 4, wherein a starting condition of the first timer comprises that the condition of the first candidate cell is met.

6. The method according to claim 4, wherein a restarting condition of the first timer comprises that a condition of a third candidate cell is met during running of the first timer, and the third candidate cell is a CHO-based candidate cell other than the first candidate cell; and/or
wherein a stopping condition of the first timer comprises one or more of following:
the condition of the second candidate cell is met;
a measurement result of the source cell of the terminal device is lower than a threshold;
a radio link failure (RLF) occurs in the source cell of the terminal device; or
an RLF-related timer is started.

7. The method according to claim 4, wherein if the first time is a time after the first timer stops, the accessing the first candidate cell at the first time comprises accessing only the first candidate cell at the first time.

8. The method according to claim 4, wherein the method further comprises:
releasing, by the terminal device, an SCG if the first timer expires.

9. A terminal device, comprising a memory and a processor, wherein the memory is configured to store a program, and the processor is configured to execute the computer program to cause the terminal device to:
execute a first operation if a condition of a first candidate cell is met and a condition of a second candidate cell is not met,
wherein the first candidate cell is a conditional handover (CHO) candidate cell, the second candidate cell is a conditional primary secondary cell addition/change (CPAC) candidate cell, and the first candidate cell is associated with the second candidate cell; and
the first operation comprises one or more of following:
accessing the first candidate cell at a first time;
accessing the first candidate cell;
releasing or maintaining a serving secondary cell group (SCG);
evaluating the second candidate cell;
stopping evaluating the second candidate cell;
evaluating the first candidate cell;
stopping evaluating the first candidate cell; or
camping on a source cell.

10. The terminal device according to claim 9, wherein if the first operation comprises maintaining the serving SCG, the serving SCG belongs to a candidate SCG list.

11. The terminal device according to claim 10, wherein a condition of the serving SCG is used to execute a CPC based on the serving SCG, and the processor is configured to execute the computer program to cause the terminal device further to:
set the serving SCG to a deactivated state if the condition of the serving SCG is not met; and/or
set the serving SCG to an activated state if the condition of the serving SCG is met.

12. The terminal device according to claim 9, wherein if the first operation comprises releasing the serving SCG, the serving SCG does not belong to a candidate SCG list; or
wherein if the first operation comprises camping on the source cell, and the first operation is executed after a third timer stops, a stopping condition of the third timer comprises: signal quality of the first candidate cell is lower than a threshold; and/or signal quality of the source cell of the terminal device is higher than a threshold.

13. The terminal device according to claim 9, wherein if the first operation comprises evaluating the second candidate cell or stopping evaluating the second candidate cell, the processor is configured to execute the computer program to cause the terminal device further to:
determine, based on first information, to evaluate the second candidate cell or to stop evaluating the second candidate cell.

14. The terminal device according to claim 13, wherein the first information is used to indicate evaluating the second candidate cell or stopping evaluating the second candidate cell.

15. The terminal device according to claim 14, wherein if the first information indicates stopping evaluating the second candidate cell, the first information is further used to determine to release or maintain a CPAC configuration of the second candidate cell.

16. The terminal device according to claim 13, wherein the first information is used to indicate a node that configures the condition of the second candidate cell, and the node comprises one or more of a source MN, a source SN, a candidate MN, or a candidate SN.

17. The terminal device according to claim 16, wherein if the first information indicates that the node is the source MN, the terminal device stops evaluating the second candidate cell; and/or
if the first information indicates that the node is the candidate MN, and the terminal device is handed over to the candidate MN, the terminal device evaluates the second candidate cell; and/or
if the first information indicates that the node is the source SN, and the terminal device is handed over to the first candidate cell and maintains the source SN, the terminal device evaluates the second candidate cell; and/or
if the first information indicates that the node is the candidate SN, the terminal device evaluates the second candidate cell.

18. The terminal device according to claim 13, wherein the first information is used to indicate a node used to trigger a CPAC associated with the second candidate cell, and the node comprises one or more of a source MN, a source SN, or a candidate MN.

19. The terminal device according to claim 18, wherein if the first information indicates that the node is the source MN, the terminal device stops evaluating the second candidate cell; and/or
if the first information indicates that the node is the candidate MN, and the terminal device is handed over to the candidate MN, the terminal device evaluates the second candidate cell; and/or
if the first information indicates that the node is the source SN, and the terminal device is handed over to the first candidate cell and maintains the source SN, the terminal device evaluates the second candidate cell; and/or
if the first information indicates that the node is the source SN, and the terminal device is handed over to the first candidate cell and releases the source SN, the terminal device stops evaluating the second candidate cell.

20. A chip, comprising a processor, configured to invoke a program from a memory, to cause a device on which the chip is installed to execute a first operation if a condition of a first candidate cell is met and a condition of a second candidate cell is not met,
wherein the first candidate cell is a conditional handover (CHO) candidate cell, the second candidate cell is a conditional primary secondary cell addition/change (CPAC) candidate cell, and the first candidate cell is associated with the second candidate cell; and
the first operation comprises one or more of following:
accessing the first candidate cell at a first time;
accessing the first candidate cell;
releasing or maintaining a serving secondary cell group (SCG);
evaluating the second candidate cell;
stopping evaluating the second candidate cell;
evaluating the first candidate cell;
stopping evaluating the first candidate cell; or
camping on a source cell.
